(19) United States
(12) Patent Application Publication
(10) Pub. No.: US 2025/0275652 A1
(43) Pub. Date: Sep. 4, 2025

(54) HEATING SPOON

(71) Applicant: ACE SMART&TECH (NINGBO) CO., LTD., Ningbo (CN)

(72) Inventors: Yanbei QIN, Ningbo (CN); Wanni QIN, Ningbo (CN)

(73) Assignee: ACE SMART&TECH (NINGBO) CO., LTD., Ningbo, ZJ (CN)

(21) Appl. No.: 18/918,108

(22) Filed: Oct. 17, 2024

(30) Foreign Application Priority Data
Feb. 29, 2024 (CN) 202420384780.3

(51) Int. Cl. A47J 43/28

(52) U.S. Cl. CPC A47J 43/282

(57) ABSTRACT

Provided is a heating spoon, including a handle; a bowl connected to the handle; a heating element arranged in the bowl; and a power supply element arranged in the handle, the power supply element being electrically connected to the heating element and supplying power to the heating element. The invention has the following beneficial effects: the power supply element is electrically connected to the heating element and supplies power to the heating element; the heating element heats the bowl rather than the handle, so that food can be heated and the handle will not be too hot to hold.

### BACKGROUND OF THE INVENTION

### 1. Technical Field

The present invention belongs to the technical field of spoons and relates to a heating spoon.

### 2. Description of Related Art

Spoons, as daily necessities, are mostly made of aluminum alloy or stainless steel. The bowls of the spoons are often semi-elliptical or semi-circular for scooping food. Spoons are frequently used in daily life.

It is difficult to scoop up frozen food with some existing spoons, such as ice cream spoons. For another example, because some food which is relatively cold may cause discomfort if it is eaten directly, the food needs to be heated. Existing spoons lack the heating function and may be too hot to hold after being heated. So they need further improvement.

### BRIEF SUMMARY OF THE INVENTION

In view of the problems existing in the prior art, an objective of the present invention is to provide a heating spoon.

The objective of the present invention can be achieved through the following technical solution: A heating spoon, including:

a handle;

a bowl connected to the handle;

a heating element arranged in the bowl; and

a power supply element arranged in the handle, the power supply element being electrically connected to the heating element and supplying power to the heating element.

The heating spoon further includes a circuit board and a control button, wherein the circuit board is arranged in the handle, the control button is arranged on the handle, the heating element is electrically connected to the power supply element by the circuit board, and the control button is electrically connected to the circuit board and is capable of controlling the heating element to work.

The heating spoon further includes indicator lights, wherein the indicator lights are arranged in the handle, the handle is provided with light-transmitting holes, the indicator lights are electrically connected to the circuit board, the power supply element is capable of supplying power to the indicator lights by means of the circuit board, and the indicator lights are aligned with the light-transmitting holes.

In the heating spoon, the power supply element is a rechargeable battery.

In the heating spoon, the handle is provided with a USB interface, the USB interface is electrically connected to the circuit board, and the USB interface is capable of charging the power supply element by means of the circuit board.

The heating spoon further includes a dustproof block, the dustproof block is detachably connected to the handle, and the dustproof block seals the USB interface when connected to the handle.

In the heating spoon, the bowl includes a heat-resistant portion and a heat-conducting portion, the heat-resistant portion is connected to the handle, the heat-conducting portion is connected to the heat-resistant portion and is away from the handle, and the heating element is located in the heat-conducting portion.

In the heating spoon, the heat-conducting portion is a metal part.

In the heating spoon, the heat-resistant portion is a plastic part.

In the heating spoon, the handle is a plastic part.

In the heating spoon, the heating element is a heating ring, and the heating ring is embedded in the heat-conducting portion.

In the heating spoon, the heat-resistant portion is provided with a stop recess, the heat-conducting portion is provided with a stop protrusion, and the stop protrusion is inserted into the stop recess.

In the heating spoon, the heat-resistant portion is provided with a stop protrusion, the heat-conducting portion is provided with a stop recess, and the stop protrusion is inserted into the stop recess.

In the heating spoon, the heat-resistant portion extends in a circumferential direction of the handle to form a protective portion.

Compared with the prior art, the present invention has the following beneficial effects:

1. The power supply element is electrically connected to the heating element and supplies power to the heating element. The heating element heats the bowl rather than the handle. In this way, food can be heated and the handle will not be too hot to hold.

2. The control button is electrically connected to the circuit board and electrically connected to the heating element by means of the circuit board. The control button is capable of controlling the heating element to work by means of the circuit board so that the user can control the heating element to work or not to work by means of the control button.

3. The power supply element is capable of supplying power to the indicator lights by means of the circuit board so that the indicator lights are aligned with the light-transmitting holes to emit light, indicating the working and charging states of the heating spoon and preventing users from accidentally touching the bowl with a high temperature.

4. The USB interface is capable of charging the power supply element by means of the circuit board, so that the heating spoon can be carried conveniently.

5. The dustproof block seals the USB interface when detachably connected to the handle, thereby preventing the USB interface from dust.

6. The heating element is located in the heat-conducting portion and heats up by means of the heat-conducting portion, and the heat-resistant portion connected to the heat-conducting portion can withstand the temperature of the heat-conducting portion. So, the heat of the heat-conducting portion can be prevented from being directly transferred to the handle, and the handle will not be too hot.

7. The heating ring is embedded in the heat-conducting portion so that the heat-conducting portion can conduct heat uniformly, thereby ensuring that the surface temperature of the heat-conducting portion is uniform.

### BRIEF DESCRIPTION OF THE SEVERAL VIEWS OF THE DRAWINGS

FIG. 1 is a schematic structural diagram of a heating spoon of the present invention.

FIG. 2 is a schematic structural diagram of the heating spoon of the present invention from another perspective.

FIG. 3 is an exploded diagram of the heating spoon of the present invention.

FIG. 4 is an exploded diagram of the heating spoon of the present invention from another perspective.

In the figures: 100, handle; 110, light-transmitting hole; 120, USB interface; 200, bowl; 210, heat-resistant portion; 211, stop recess; 212, protective portion; 220, heat-conducting portion; 221, stop protrusion; 300, heating element; 400, power supply element; 500, circuit board; 600, control button; 700, indicator light; 800, dustproof block.

### DETAILED DESCRIPTION OF THE INVENTION

The technical solution of the invention is further described below with reference to specific embodiments and accompanying drawings, but the invention is not limited to these embodiments.

It should be noted that all directional indications in the embodiments of the present invention (such as upper, lower, left, right, front, and back) are only used to explain the relative position relationship, movement, etc. between the components under a certain posture (as shown in the accompanying drawings). If the specific posture changes, the directional indications will change accordingly.

In addition, in the present invention, the descriptions such as “first”, “second”, and “one”, are only used for descriptive purposes, and should not be construed as indicating or implying relative importance or implicitly indicating the number of technical features indicated. Therefore, the features defined by “first” and “second” may explicitly or implicitly include at least one of the features. In the description of the present invention, the meaning of “multiple” is at least two, such as two and three, unless otherwise clearly and specifically defined.

In the present invention, unless otherwise clearly specified and defined, the terms “connect”, “fix”, etc. should be understood in a broad sense. For example, “fix” may be a fixed connection, a detachable connection, or an integral connection; it may be a mechanical connection or an electrical connection; it may be a direct connection or an indirect connection by means of an intermediate medium; it may be the internal connection of two elements or the interaction relationship between two elements, unless otherwise clearly defined. For those of ordinary skill in the art, the specific meanings of these terms in the invention can be understood according to specific circumstances.

In addition, the technical solutions of the various embodiments of the present invention can be combined based on the fact that those of ordinary skill in the art can implement it. When the combination of technical solutions is contradictory or cannot be achieved, it should be considered that such a combination of technical solutions does not exist and is not within the scope of the invention.

The specific embodiments described herein are only examples of the spirit of the invention. Those skilled in the technical field to which the invention belongs can make various modifications or supplements to the described specific embodiments or replace them in a similar way, without departing from the spirit of the invention or going beyond the scope defined by the appended claims.

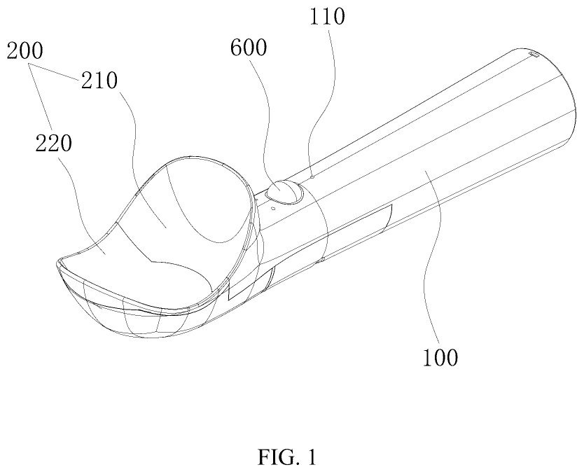

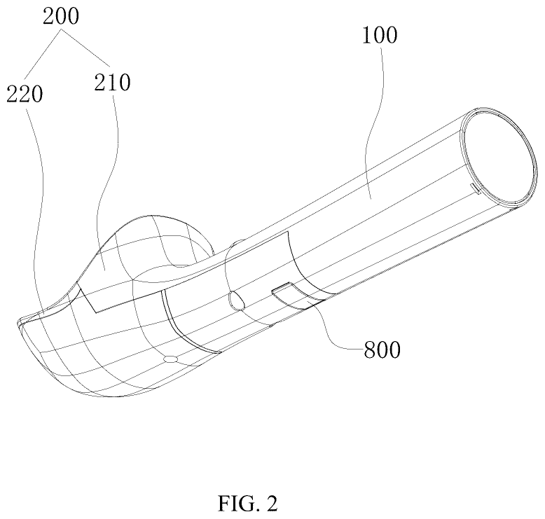

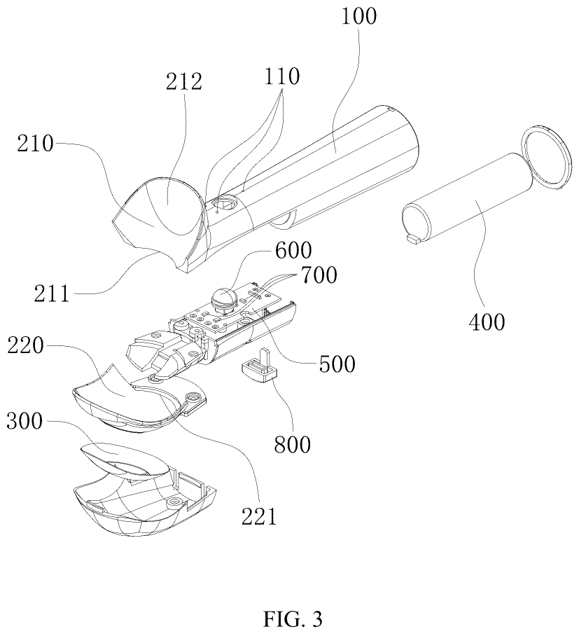

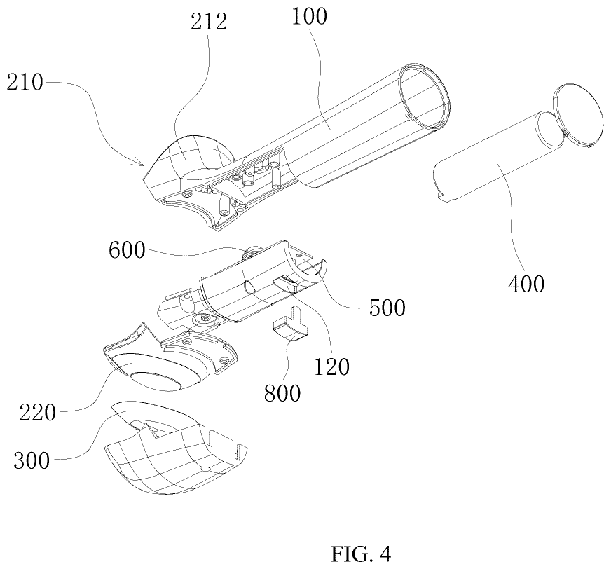

As shown in FIGS. 1-4, a heating spoon includes a handle 100, a bowl 200, a heating element 300 and a power supply element 400.

The bowl 200 is connected to the handle 100.

The heating element 300 is arranged in the bowl 200.

The power supply element 400 is arranged in the handle 100, and the power supply element 400 is electrically connected to the heating element 300 and supplies power to the heating element 300.

In this embodiment, the power supply element 400 is electrically connected to the heating element 300 and supplies power to the heating element 300. The heating element 300 heats the bowl 200 rather than the handle 100. In this way, food can be heated and the handle 100 will not be too hot to hold.

As shown in FIGS. 1-4, based on the above embodiment, the heating spoon further includes a circuit board 500 and a control button 600, wherein the circuit board 500 is arranged in the handle 100, the control button 600 is arranged on the handle 100, the heating element 300 is electrically connected to the power supply element 400 by the circuit board 500, and the control button 600 is electrically connected to the circuit board 500 and is capable of controlling the heating element 300 to work.

In this embodiment, the control button 600 is electrically connected to the circuit board 500 and electrically connected to the heating element 300 by means of the circuit board 500. The control button 600 is capable of controlling the heating element 300 to work by means of the circuit board 500 so that users can control the heating element 300 to work or not to work by means of the control button 600.

Specifically, the heating spoon has two heating modes. The temperature of a first mode is set to 60° C., and the temperature of a second mode is set to 75° C. The control button 600 is pressed and held for three seconds to start the heating spoon, then the heating spoon confirms to work in the first heating mode; the control button 600 is pressed again to enable the heating spool to work in the second heating mode, and the control button 600 is pressed for the third time to shut down the heating spoon; the control button 600 is turned on to start heating, and heating is stopped when the temperature reaches a set temperature; cyclic heating is performed when the temperature is 5° C. lower than the set temperature.

As shown in FIGS. 1-4, based on the above embodiment, the heating spoon further includes indicator lights 700, wherein the indicator lights 700 are arranged in the handle 100, the handle 100 is provided with light-transmitting holes 110, the indicator lights 700 are electrically connected to the circuit board 500, the power supply element 400 is capable of supplying power to the indicator lights 700 by means of the circuit board 500, and the indicator lights 700 are aligned with the light-transmitting holes 110.

In this embodiment, the power supply element 400 is capable of supplying power to the indicator lights 700 by means of the circuit board 500 so that the indicator lights 700 are aligned with the light-transmitting holes 110 to emit light, indicating the working and charging states of the heating spoon and preventing users from accidentally touching the bowl 200 with a high temperature.

Specifically, the indicator lights 700 flash in a heating mode, and the indicator lights 700 are always on when the set temperature is reached; the lights flash in a charging mode, and the lights are always on when the power supply element is fully charged.

As shown in FIGS. 1-4, based on the above embodiment, the power supply element 400 is a rechargeable battery.

As an embodiment, the handle 100 is provided with a USB interface 120, and the USB interface 120 is electrically connected to the circuit board 500. The USB interface 120 is capable of charging the power supply element 400 by means of the circuit board 500, so that the heating spoon can be carried conveniently.

As an embodiment, the handle 100 is provided with a plug, and the plug is electrically connected to the circuit board 500. The plug is capable of charging the power supply element 400 by means of the circuit board 500.

As shown in FIGS. 1-4, based on the above embodiment, the heating spoon further includes a dustproof block 800, the dustproof block 800 is detachably connected to the handle 100, and the dustproof block 800 seals the USB interface 120 when connected to the handle 100.

In this embodiment, the dustproof block 800 seals the USB interface 120 when detachably connected to the handle 100, thereby preventing the USB interface 120 from dust.

As shown in FIGS. 1-4, based on the above embodiment, the bowl 200 includes a heat-resistant portion 210 and a heat-conducting portion 220, the heat-resistant portion 210 is connected to the handle 100, the heat-conducting portion 220 is connected to the heat-resistant portion 210 and is away from the handle 100, and the heating element 300 is located in the heat-conducting portion 220.

In this embodiment, the heating element 300 is located in the heat-conducting portion 220 and heats up by means of the heat-conducting portion 220, and the heat-resistant portion 210 connected to the heat-conducting portion 220 can withstand the temperature of the heat-conducting portion 200. So, the heat of the heat-conducting portion 220 can be prevented from being directly transferred to the handle 100, and the handle 100 will not be too hot.

Preferably, the heat-conducting portion 220 is a metal part.

Preferably, the heat-resistant portion 210 and the handle 100 are both plastic parts.

As shown in FIGS. 1-4, based on the above embodiment, the heating element 300 is a heating ring, and the heating ring is embedded in the heat-conducting portion 220.

In this embodiment, the heating ring is embedded in the heat-conducting portion 220 so that the heat-conducting portion 220 can conduct heat uniformly, thereby ensuring that the surface temperature of the heat-conducting portion 220 is uniform.

As shown in FIGS. 1-4, based on the above embodiment, the heat-resistant portion 210 is provided with a stop recess 211, and the heat-conducting portion 220 is provided with a stop protrusion 221, and the stop protrusion 221 is inserted into the stop recess 211.

In this embodiment, the stop protrusion 221 is inserted into the stop recess 211 so that the heat-resistant portion 210 and the heat-conducting portion 220 are accurately connected together.

As another embodiment, it is also possible that the heat-resistant portion 210 is provided with a stop protrusion 221, the heat-conducting portion 220 is provided with a stop recess 211, and the stop protrusion 221 is inserted into the stop recess 211.

As shown in FIGS. 1 to 4, based on the above-mentioned embodiment, the heat-resistant portion 210 extends in a circumferential direction of the handle 100 to form a protective portion 212.

In this embodiment, when holding the handle 100, the user may press against the protective portion 212 with fingers, so as to keep the palm away from the heat-conducting portion 220 and prevent the palm from being scalded.

What is claimed is:

1. A heating spoon, comprising:
a handle;
a bowl connected to the handle;
a heating element arranged in the bowl; and
a power supply element arranged in the handle, the power supply element being electrically connected to the heating element and supplying power to the heating element.

2. The heating spoon according to claim 1, further comprising a circuit board and a control button, wherein the circuit board is arranged in the handle, the control button is arranged on the handle, the heating element is electrically connected to the power supply element by the circuit board, and the control button is electrically connected to the circuit board and is capable of controlling the heating element to work.

3. The heating spoon according to claim 2, further comprising indicator lights, wherein the indicator lights are arranged in the handle, the handle is provided with light-transmitting holes, the indicator lights are electrically connected to the circuit board, the power supply element is capable of supplying power to the indicator lights by means of the circuit board, and the indicator lights are aligned with the light-transmitting holes.

4. The heating spoon according to claim 2, wherein the power supply element is a rechargeable battery.

5. The heating spoon according to claim 4, wherein the handle is provided with a USB interface, the USB interface is electrically connected to the circuit board, and the USB interface is capable of charging the power supply element by means of the circuit board.

6. The heating spoon according to claim 5, further comprising a dustproof block, wherein the dustproof block is detachably connected to the handle, and the dustproof block seals the USB interface when connected to the handle.

7. The heating spoon according to claim 1, wherein the bowl comprises a heat-resistant portion and a heat-conducting portion, the heat-resistant portion is connected to the handle, the heat-conducting portion is connected to the heat-resistant portion and is away from the handle, and the heating element is located in the heat-conducting portion.

8. The heating spoon according to claim 7, wherein the heat-conducting portion is a metal part.

9. The heating spoon according to claim 7, wherein the heat-resistant portion is a plastic part.

10. The heating spoon according to claim 7, wherein the handle is a plastic part.

11. The heating spoon according to claim 1, wherein the heating element is a heating ring, and the heating ring is embedded in the heat-conducting portion.

12. The heating spoon according to claim 7, wherein the heat-resistant portion is provided with a stop recess, the heat-conducting portion is provided with a stop protrusion, and the stop protrusion is inserted into the stop recess.

13. The heating spoon according to claim 7, wherein the heat-resistant portion is provided with a stop protrusion, the heat-conducting portion is provided with a stop recess, and the stop protrusion is inserted into the stop recess.

14. The heating spoon according to claim 7, wherein the heat-resistant portion extends in a circumferential direction of the handle to form a protective portion.
